(19) United States
(12) Patent Application Publication
(10) Pub. No.: US 2025/0194683 A1
(43) Pub. Date: Jun. 19, 2025

(54) AEROSOL GENERATION DEVICE

(71) Applicant: SHENZHEN FIRST UNION TECHNOLOGY CO., LTD., Shenzhen, Guangdong (CN)

(72) Inventors: Huabo WANG, Shenzhen, Guangdong (CN); Xinjun LI, Shenzhen, Guangdong (CN); Rui HONG, Shenzhen, Guangdong (CN); Xiaogang FANG, Shenzhen, Guangdong (CN); Ruilong HU, Shenzhen, Guangdong (CN); Yinzhe LI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/847,760

(22) PCT Filed: Mar. 21, 2023
(86) PCT No.: PCT/CN2023/082788

§ 371 Date: Sep. 17, 2024

(30) Foreign Application Priority Data
Mar. 22, 2022 (CN) 202210287746.X

(51) Int. Cl. A24F 40/46; A24F 40/20; A24F 40/485; A24F 40/57; H05H 1/24

(52) U.S. Cl. CPC A24F 40/46; H05H 1/2425; H05H 1/2431; A24F 40/20; A24F 40/485; A24F 40/57

(57) ABSTRACT

An aerosol generation device is provided. The device is configured to heat an aerosol-generating product to generate an aerosol. The device includes a plasma generator configured to generate plasma to heat the aerosol-generating product through the plasma. In the aerosol generation devices, the plasma generator provides the plasma to the aerosol-generating product to heat the aerosol-generating product.

### CROSS-REFERENCE TO RELATED APPLICATIONS

This application claims priority to Chinese Patent Application No. 202210287746.X, filed with the China National Intellectual Property Administration on Mar. 22, 2022 and entitled “AEROSOL GENERATION DEVICE”, which is incorporated herein by reference in its entirety.

### TECHNICAL FIELD

Embodiments of this application relate to the field of aerosol generation technologies through heating but not burning, and in particular, to an aerosol generation device.

### BACKGROUND

Tobacco products (such as cigarettes and cigars) are used by burning tobacco to produce tobacco smoke. Attempts are made to replace these tobacco-burning products by manufacturing products that release compounds without burning.

An example of this type of products is a heating device that releases compounds by heating rather than burning materials. For example, the materials may be an aerosol-generating product including tobacco or other non-tobacco products, where these non-tobacco products may or may not include nicotine. To heat the aerosol-generating product to a temperature at which volatile components that can form aerosols can be released, an existing heating device usually heats the aerosol-generating product by using a resistance heating element or an electromagnetic induction heating element.

### SUMMARY

An embodiment of this application provides an aerosol generation device, configured to heat an aerosol-generating product to generate an aerosol, including:
a plasma generator, configured to generate plasma to heat the aerosol-generating product through the plasma.

In a more preferred implementation, the plasma is constructed to be generated by applying a breakdown voltage to a gas to break the gas down.

In a more preferred implementation, the gas includes at least one of air, helium, and neon.

In a more preferred implementation, an electron number density of the plasma generated by the plasma generator is 10¹⁰/cm³-10¹³/cm³.

In a more preferred implementation, the plasma generated by the plasma generator further includes two or more of oxygen atoms, excited-state nitrogen molecules, ozone molecules, hydroxyl groups, oxygen ions, nitrogen ions, and nitrogen oxide molecules.

In a more preferred implementation, the plasma generator is based on atmospheric-pressure glow discharge.

In a more preferred implementation, the plasma generated by the plasma generator is non-equilibrium plasma.

In a more preferred implementation, the plasma generator is provided based on dielectric barrier discharge.

In a more preferred implementation, the plasma generator is provided based on micro hollow cathode discharge.

In a more preferred implementation, the plasma generator is configured with:
an inlet, for the gas to enter; and
an outlet, for outputting the plasma.

In a more preferred implementation, the inlet and the outlet are aligned in an axial direction of the plasma generator.

In a more preferred implementation, the inlet and the outlet are staggered relative to each other in an axial direction of the plasma generator.

In a more preferred implementation, no obstacle that blocks the plasma exists between the outlet and the aerosol-generating product.

In a more preferred implementation, the plasma generator includes a first electrode and a second electrode that are spaced apart, to form a breakdown field between the first electrode and the second electrode to break the gas down to generate the plasma.

In a more preferred implementation, the breakdown field is 10-50 kV/cm.

In a more preferred implementation, the first electrode and the second electrode are arranged substantially in parallel.

In a more preferred implementation, a spacing distance between the first electrode and the second electrode is 10-2000 km. In a more preferred implementation, a spacing distance between the first electrode and the second electrode cannot be less than 5 km.

In a more preferred implementation, the first electrode and/or the second electrode are/is in a shape of a sheet or plate or ring or tube.

In a more preferred implementation, the first electrode and/or the second electrode are/is rigid.

In a more preferred implementation, the first electrode and/or the second electrode are/is thin.

In a more preferred implementation, the first electrode and/or the second electrode have/has a length, a width, and a thickness; and the thickness of the first electrode and/or the second electrode is less than the length and the width.

In a more preferred implementation, the first electrode and/or the second electrode have/has a thickness of 0.05-0.5 mm.

In a more preferred implementation, the first electrode and/or the second electrode have/has the same shape or size.

In a more preferred implementation, the first electrode and/or the second electrode have/has resistivity of about 1×10⁻⁹-1×10⁻⁵ Ωm.

In a more preferred implementation, the first electrode and/or the second electrode include/includes copper, gold, silver, platinum, or an alloy thereof.

In a more preferred implementation, the breakdown field is intermittent or pulsed.

In a more preferred implementation, the plasma generator further includes:
a dielectric, at least partially located between the first electrode and the second electrode, for inhibiting discharge-to-arc transition between the first electrode and the second electrode.

In a more preferred implementation, the dielectric is arranged to be a coating or film layer formed on a surface of the first electrode and/or the second electrode.

In a more preferred implementation, a dielectric constant of the dielectric is greater than 5.

In a more preferred implementation, the dielectric includes at least one of aluminum oxide, zirconium oxide, ceramic, glass, quartz, and an organic polymer.

In a more preferred implementation, the plasma generator has a fluid channel running through the plasma generator; and
the fluid channel at least partially extends in the dielectric; or the fluid channel is at least partially formed between the dielectric and the first electrode; or the fluid channel is at least partially formed between the dielectric and the second electrode.

In a more preferred implementation, one of the first electrode and the second electrode is located inside the dielectric, and the other is located outside the dielectric.

In a more preferred implementation, the aerosol generation device further includes:
a substrate, arranged to emit heat by receiving at least partial plasma from the plasma generator, to heat the aerosol-generating product.

In a more preferred implementation, the substrate at least partially defines a cavity for receiving the aerosol-generating product.

In a more preferred implementation, the substrate includes a metal or an alloy.

In a more preferred implementation, thermal conductivity of the substrate is greater than 40 W/mK.

In a more preferred implementation, the substrate is arranged to be not in contact with the plasma generator; and/or
the substrate is arranged to be in contact with the aerosol-generating product.

In a more preferred implementation, the plasma generator is arranged to at least partially surround the substrate.

In a more preferred implementation, the substrate is provided with a hole, and at least partial plasma from the plasma generator is outputted to the aerosol-generating product through the hole.

In a more preferred implementation, the plasma generator is provided with a high-voltage pulse power supply.

In a more preferred implementation, the aerosol generation device further includes:
a cell; and
a circuit board, located between the cell and the plasma generator, and configured to guide and provide an impulse voltage to the plasma generator for the plasma generator to generate the plasma.

In some other varying implementations, a direct-current voltage, an alternating-current voltage, a radio-frequency voltage, or the like is provided to the plasma generator, and then an electric field is generated through the excitation by the direct-current voltage, the alternating-current voltage, the radio-frequency voltage, or the like, to break a gas down to generate plasma. Alternatively, the plasma generator is excited by a direct-current voltage, an alternating-current voltage, or a radio-frequency voltage to generate an electric field to break a gas down to generate plasma.

In a more preferred implementation, frequency of the impulse voltage is 1-100 kHz.

In a more preferred implementation, a voltage amplitude of the impulse voltage is 1-9 kV.

In a more preferred implementation, an impulse width of the impulse voltage is 10-600 ns.

In a more preferred implementation, the impulse voltage is obtained by boosting an output voltage of the cell at least twice.

In a more preferred implementation, the circuit board includes:
an inverting boost circuit, configured to perform a first boost on a direct-current voltage outputted by the cell;
a Cockcroft-Walton boost circuit, for performing a second boost on an output voltage of the inverting boost circuit; and
a filter circuit, for filtering an output voltage of the Cockcroft-Walton boost circuit to form the impulse voltage.

In a more preferred implementation, the plasma generator is constructed to extend substantially in a longitudinal direction of the aerosol generation device.

In a more preferred implementation, the plasma generator is constructed to be substantially perpendicular to a longitudinal direction of the aerosol generation device.

In a more preferred implementation, the aerosol generation device further includes:
a cavity, configured to receive the aerosol-generating product, where
the plasma generator and the cavity are substantially arranged coaxially.

In a more preferred implementation, the aerosol generation device further includes:
a cavity, configured to receive the aerosol-generating product, where
the plasma generator and the cavity are spaced apart in a longitudinal direction of the aerosol generation device.

In a more preferred implementation, the aerosol generation device further includes:
a cavity, configured to receive the aerosol-generating product, where
the plasma generator is arranged to at least partially surround the cavity.

In a more preferred implementation, the plasma generator has a fluid channel running through the plasma generator.

In a more preferred implementation, the fluid channel substantially extends straight.

In a more preferred implementation, the fluid channel is constructed to run through the plasma generator in an axial direction.

In a more preferred implementation, the fluid channel has an inner diameter of 0.1-0.9 mm.

In a more preferred implementation, the plasma generator further includes: a first conducting element and a second conducting element for supplying power to the plasma generator, where
the first conducting element is electrically conductive with the first electrode; and
the second conducting element is electrically conductive with the second electrode.

In a more preferred implementation, the first conducting element is further arranged to at least partially provide support to the first electrode; and/or the second conducting element is further arranged to at least partially provide support to the second electrode.

In a more preferred implementation, the first conducting element and/or the second conducting element are/is constructed to be in a shape of a ring or tube.

In a more preferred implementation, the first conducting element and the second conducting element are arranged coaxially.

In a more preferred implementation, the first electrode and/or the first conducting element are/is located in the second conducting element.

In a more preferred implementation, the plasma generator further includes:
a dielectric, including an end part arranged perpendicular to a longitudinal direction of the dielectric and a peripheral part extending from the end part, where
the end part is arranged to be at least partially located between the first electrode and the second electrode, for inhibiting discharge-to-arc transition between the first electrode and the second electrode; and
the peripheral part is arranged to be at least partially located between the first conducting element and the second conducting element, to provide insulation between the first conducting element and the second conducting element.

In a more preferred implementation, the plasma generator further includes:
an outer cover, at least partially defining an outer surface of the plasma generator, and making the surface of the plasma generator electrically insulated.

In a more preferred implementation, the outer cover is further arranged to accommodate and hold the first electrode and the second electrode.

In a more preferred implementation, the plasma generator further includes:
a first conducting lead and a second conducting lead for supplying power to the plasma generator, where
the first conducting lead at least partially extends from an outside of the outer cover to an inside of the outer cover, to be electrically connected to the first electrode; and/or the second conducting lead at least partially extends from an outside of the outer cover to an inside of the outer cover, to be electrically connected to the second electrode.

In a more preferred implementation, the plasma generator is constructed to output the plasma in a longitudinal direction of the plasma generator.

In a more preferred implementation, the aerosol generation device further includes:
a resistance heating element, to heat the aerosol-generating product through Joule heating; and/or
an induction heating element, to heat the aerosol-generating product by being penetrated by a varying magnetic field to emit heat; and/or
an infrared heating element, to heat the aerosol-generating product by radiating an infrared ray to the aerosol-generating product.

In a more preferred implementation, the plasma generator includes at least:
a first plasma generator and a second plasma generator, configured to independently output the plasma to different parts of the aerosol-generating product, to independently heat the different parts of the aerosol-generating product.

In a more preferred implementation, the first plasma generator and the second plasma generator are configured to heat the different parts of the aerosol-generating product one after the other.

In a more preferred implementation, the plasma generator includes at least:
a first plasma generator and a second plasma generator, configured to heat different parts of the aerosol-generating product according to different preset temperatures, to heat the different parts of the aerosol-generating product to the different temperatures.

In a more preferred implementation, the plasma generator includes at least:
a first plasma generator and a second plasma generator that are arranged adjacent to each other in a longitudinal direction; and
a mechanical isolator, disposed between the first plasma generator and the second plasma generator, and constructed and provided to keep a distance between the adjacent first plasma generator and second plasma generator.

In a more preferred implementation, the mechanical isolator is insulated and is configured to provide insulation between the adjacent first plasma generator and second plasma generator.

In a more preferred implementation, the mechanical isolator is in a shape of a ring or tube.

In a more preferred implementation, the aerosol generation device further includes:
an air inlet, for outside air to enter; and
a support element or support wall, located between the air inlet and the plasma generator, and at least partially providing support to the plasma generator, where
the support element or support wall further defines an air channel connecting the air inlet and the plasma generator.

Another embodiment of this application further provides an aerosol generation device, configured to heat an aerosol-generating product to generate an aerosol, including:
a plasma generator, configured to generate plasma; and
a substrate, arranged to emit heat by receiving the plasma from the plasma generator, to heat the aerosol-generating product.

In a more preferred implementation, the substrate at least partially defines a cavity for receiving the aerosol-generating product.

Another embodiment of this application further provides an aerosol generation device, configured to heat an aerosol-generating product to generate an aerosol, including:
a first plasma generator and a second plasma generator that are spaced apart in a longitudinal direction, configured to output plasma to different parts of the aerosol-generating product one after the other, to sequentially heat the different parts of the aerosol-generating product.

Another embodiment of this application further provides an aerosol generation device, configured to heat an aerosol-generating product to generate an aerosol, including:
a plasma generator, configured to provide plasma to heat the aerosol-generating product; and
a circuit board, configured to guide and provide an impulse voltage to the plasma generator for the plasma generator to stably provide the plasma to the aerosol-generating product, to stably heat or cool the aerosol-generating product.

In the foregoing aerosol generation devices, the plasma generator provides the plasma to the aerosol-generating product to heat the aerosol-generating product.

Another embodiment of this application further provides an electronic atomization device, configured to atomize a liquid substrate to generate an aerosol, including:
a liquid storage cavity, configured to store the liquid substrate;
a capillary element, configured to receive and hold the liquid substrate from the liquid storage cavity; and
a plasma generator, configured to provide plasma to the capillary element to at least partially heat and atomize the liquid substrate in the capillary element through plasma heating to generate the aerosol.

In a more preferred implementation, the capillary element includes a porous body, a porous fiber, a capillary tube, and the like.

In a more preferred implementation, the electronic atomization device further includes:
a liquid transfer element, configured to provide the liquid substrate from the liquid storage cavity to the capillary element. The liquid transfer element includes a liquid pump.

Another embodiment of this application further provides an aerosol generation device, configured to heat an aerosol-generating product to generate an aerosol, including an outer shell, where the outer shell is configured with:
a cavity, for at least partially receiving the aerosol-generating product;
a power supply component, configured to supply power; and
a plasma generator, configured to output plasma to the aerosol-generating product received in the cavity, where the plasma generator includes:
a first electrode and a second electrode that are spaced apart, configured to form a breakdown field when powered by the power supply component, to break a gas down to generate the plasma;
a dielectric, at least partially located between the first electrode and the second electrode, for inhibiting discharge-to-arc transition between the first electrode and the second electrode;
an inlet, for the gas to enter; and
an outlet, for outputting the plasma.

In a more preferred implementation, the plasma generator is spaced apart from the cavity in a longitudinal direction of the outer shell, and is constructed to output the plasma in the longitudinal direction of the outer shell to the aerosol-generating product received in the cavity.

In a more preferred implementation, the aerosol generation device further includes:
an air channel, located in the longitudinal direction of the outer shell between the outlet of the plasma generator and the cavity, for providing a path for the plasma to be outputted from the plasma generator to the aerosol-generating product.

In a more preferred implementation, the air channel extends straight.

In a more preferred implementation, the air channel has an extended length of 10-30 mm; or
a distance between the plasma generator and the cavity is 10-30 mm.

In a more preferred implementation, a spacing distance between the first electrode and the second electrode is 10-2000 μm.

In a more preferred implementation, the first electrode and the second electrode are substantially planar and are arranged perpendicular to the longitudinal direction of the outer shell.

In a more preferred implementation, the first electrode and/or the second electrode have/has a thickness of 0.05-0.5 mm.

In a more preferred implementation, a dielectric constant of the dielectric is greater than 5.

In a more preferred implementation, one of the first electrode and the second electrode is located inside the dielectric, and the other is located outside the dielectric.

In a more preferred implementation, the plasma generator further includes: a first conducting element and a second conducting element, located between the power supply component and the plasma generator, for forming an electrical connection between the power supply component and the plasma generator, where
the first conducting element is electrically conductive with the first electrode; and
the second conducting element is electrically conductive with the second electrode.

In a more preferred implementation, the first conducting element is further arranged to at least partially provide support to the first electrode; and/or
the second conducting element is further arranged to at least partially provide support to the second electrode.

In a more preferred implementation, the first conducting element and/or the second conducting element are/is constructed to be in a shape of a ring or tube.

In a more preferred implementation, the first conducting element and the second conducting element are arranged coaxially.

In a more preferred implementation, the first electrode and/or the first conducting element are/is located in the second conducting element.

In a more preferred implementation, the plasma generator further includes:
a dielectric, including an end part arranged perpendicular to a longitudinal direction of the dielectric and a peripheral part extending from the end part, where
the end part is arranged to be at least partially located between the first electrode and the second electrode; and
the peripheral part is arranged to be at least partially located between the first conducting element and the second conducting element, to provide electrical insulation between the first conducting element and the second conducting element.

In a more preferred implementation, the outlet and the inlet of the plasma generator are provided opposite to each other in the longitudinal direction.

In a more preferred implementation, the plasma generator further includes a fluid channel extending between the inlet and the outlet; and
the fluid channel is at least partially located between the first electrode and the second electrode.

In a more preferred implementation, the plasma generator further includes:
an outer cover, at least partially defining an outer surface of the plasma generator, and making the surface of the plasma generator electrically insulated.

In a more preferred implementation, the outer cover is further arranged to accommodate and hold the first electrode and the second electrode.

In a more preferred implementation, the plasma generator further includes:
a first conducting lead and a second conducting lead for supplying power to the plasma generator, where
the first conducting lead at least partially extends from an outside of the outer cover to an inside of the outer cover, to be electrically connected to the first electrode; and/or the second conducting lead at least partially extends from an outside of the outer cover to an inside of the outer cover, to be electrically connected to the second electrode.

In a more preferred implementation, the aerosol generation device further includes:
an air inlet, for outside air to enter; and
a support element or support wall, located between the air inlet and the plasma generator, and at least partially providing support to the plasma generator, where
the support element or support wall further defines an air channel connecting the air inlet and the plasma generator.

In a more preferred implementation, the inlet includes one or more holes formed on one of the first electrode and the second electrode; and/or
the outlet includes one or more holes formed on the other of the first electrode and the second electrode.

In a more preferred implementation, the power supply component is configured to provide an impulse voltage; and
the first electrode and the second electrode are configured to form a breakdown field when excited by the impulse voltage, to break a gas down to generate the plasma.

In some other varying implementations, the plasma generator may be further excited by a direct-current voltage, an alternating-current voltage, a radio-frequency voltage, or the like to generate an electric field to break a gas down to generate plasma.

In a more preferred implementation, the power supply component includes:
a cell, configured to provide a direct-current voltage; and
a circuit board, configured to convert the direct-current voltage provided by the cell into an impulse voltage for outputting.

Another embodiment of this application further provides a plasma generator for an aerosol generation device, including:
a first electrode and a second electrode that are spaced apart, configured to form a breakdown field when excited by the impulse voltage, to break a gas down to generate the plasma, where the first electrode and the second electrode are substantially planar and are arranged perpendicular to a longitudinal direction of the plasma generator;
a dielectric, at least partially located between the first electrode and the second electrode, for inhibiting discharge-to-arc transition between the first electrode and the second electrode;
an inlet, for the gas to enter; and
an outlet, for outputting the plasma.

Another embodiment of this application further provides an aerosol generation device, configured to heat an aerosol-generating product to generate an aerosol, including:
a substrate, for at least partially receiving the aerosol-generating product;
a power supply component, configured to supply power; and
a plasma generator, at least partially surrounding the substrate, and configured to output plasma to the substrate for the substrate to emit heat to heat the aerosol-generating product, where the plasma generator includes:
a first electrode and a second electrode that are spaced apart, configured to form a breakdown field when excited by the impulse voltage, to break a gas down to generate the plasma;
a dielectric, at least partially located between the first electrode and the second electrode, for inhibiting discharge-to-arc transition between the first electrode and the second electrode;
an inlet, for the gas to enter; and
an outlet, for outputting the plasma to the substrate.

### BRIEF DESCRIPTION OF THE DRAWINGS

One or more embodiments are exemplarily described with reference to the corresponding figures in the accompanying drawings, and these exemplary descriptions are not to be construed as limiting the embodiments. Elements that have same reference numerals in the accompanying drawings indicate similar elements. Unless otherwise particularly stated, the figures in the accompanying drawings are not drawn to scale.

FIG. 1 is a schematic diagram of an aerosol generation device according to an embodiment;

FIG. 2 is a schematic diagram of a plasma generator in FIG. 1 according to an embodiment;

FIG. 3 is a schematic diagram of a plasma generator in FIG. 1 according to another embodiment;

FIG. 4 is a schematic diagram of a plasma generator in FIG. 1 according to another embodiment;

FIG. 5 is a schematic diagram of a plasma generator in FIG. 1 according to another embodiment;

FIG. 6 is a schematic diagram of a plasma generator in FIG. 1 according to another embodiment;

FIG. 7 is a schematic diagram of a plasma generator in FIG. 1 according to another embodiment;

FIG. 8 is a schematic diagram of a plasma generator in FIG. 1 according to another embodiment;

FIG. 9 is a schematic diagram of an aerosol generation device according to another embodiment;

FIG. 10 is a schematic diagram of a plasma generator in FIG. 9 from a view angle;

FIG. 11 is a schematic diagram of a plasma generator in FIG. 9 from another view angle;

FIG. 12 is a schematic exploded diagram of all parts of a plasma generator in FIG. 9 from a view angle;

FIG. 13 is a schematic exploded diagram of all parts of a plasma generator in FIG. 9 from another view angle;

FIG. 14 is a schematic cross-sectional view of a plasma generator in FIG. 9 from a view angle;

FIG. 15 is a schematic exploded diagram of a first electrode and a second electrode before assembly according to another embodiment;

FIG. 16 is a schematic exploded diagram of a first electrode and a second electrode before assembly according to another embodiment;

FIG. 17 is a schematic diagram of an aerosol generation device according to another embodiment;

FIG. 18 is a schematic cross-sectional view of a plasma generation mechanism in FIG. 17 from a view angle;

FIG. 19 is a schematic exploded diagram of a plasma generation mechanism in FIG. 18 from a view angle;

FIG. 20 is a schematic planar diagram of a first plasma generator in FIG. 19 from a view angle;

FIG. 21 is a schematic exploded diagram of a first plasma generator in FIG. 20;

FIG. 22 is an enlarged view of B in FIG. 18;

FIG. 23 is a schematic diagram of an aerosol generation device according to another embodiment;

FIG. 24 is a schematic diagram of an aerosol generation device according to another embodiment;

FIG. 25 is a block diagram of some circuits of a circuit board according to an embodiment;

FIG. 26 is a schematic diagram of an impulse voltage provided by a circuit board to a plasma generator according to an embodiment;

FIG. 27 is a schematic diagram of a heating curve of an aerosol-generating product according to an embodiment;

FIG. 28 is a schematic diagram of an electronic atomization device according to another embodiment;

FIG. 29 is a schematic diagram of a plasma generator according to another embodiment; and

FIG. 30 is a schematic diagram of a plasma generator according to another embodiment.

### DETAILED DESCRIPTION

For ease of understanding of this application, this application is described below in more detail with reference to the accompanying drawings and specific implementations.

An embodiment of the present invention provides an aerosol generation device that heats but not burns an aerosol-generating product 1000, for example, a cigarette, to volatilize or release at least one of components of the aerosol-generating product 1000 to form an aerosol for inhalation.

Further, in an optional implementation, the aerosol-generating product 1000 is preferably made of a tobacco-containing material that releases a volatile compound from a substrate when being heated, or may be made of a non-tobacco material suitable for releasing smoke through electrical heating after being heated. The aerosol-generating product 1000 preferably uses a solid substrate, which may include one or more of powders, particles, fragmented strips, strips, or flakes of one or more of vanilla leaves, tobacco leaves, homogeneous tobacco, and expanded tobacco. Alternatively, the solid substrate may include additional tobacco or non-tobacco volatile aroma compounds to be released when the substrate is heated.

According to an embodiment of the present invention, an aerosol generation device generates plasma and heats the aerosol-generating product 1000 using the plasma.

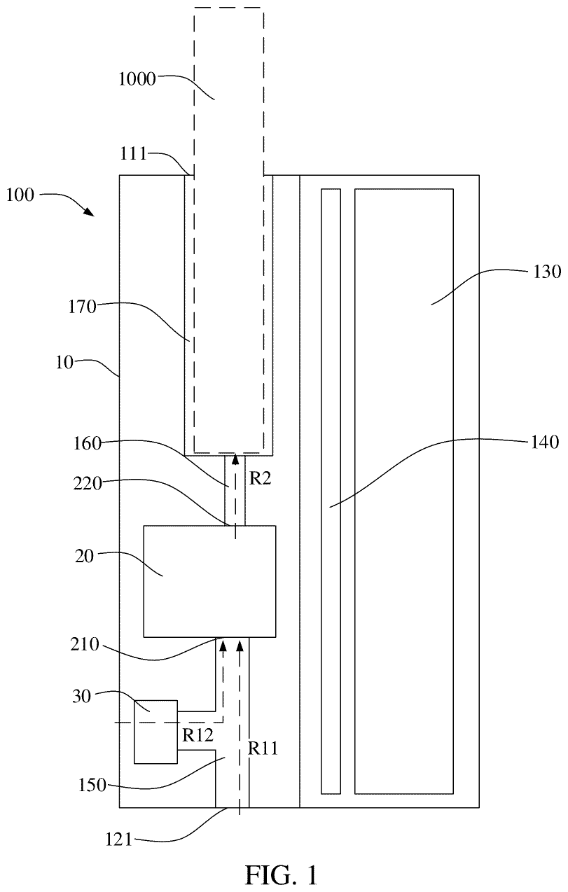

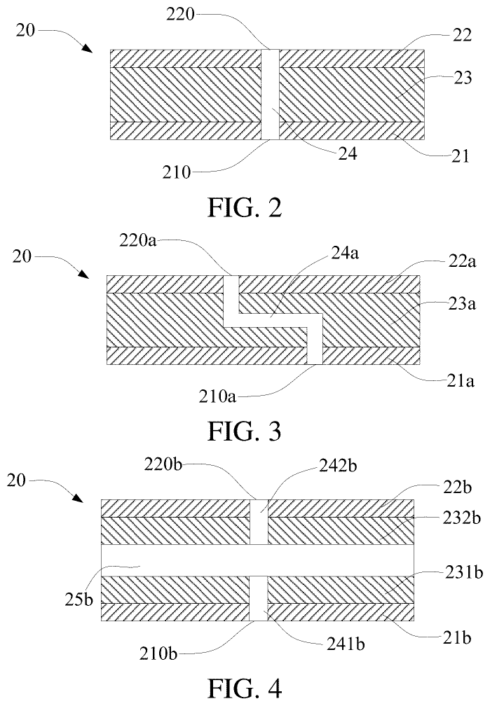

A configuration of an aerosol generation device according to an embodiment of the present invention may be shown in FIG. 1 and FIG. 2. The overall shape of the device is roughly configured into a flat cylinder shape, and an external member of the aerosol generation device 100 includes:
a housing 10, having a hollow structure inside, to form an assembly space for a component with a necessary function, for example, plasma generation, where the housing 10 has a proximal end 110 and a distal end 120 opposite to each other in a length direction.

The proximal end 110 is provided with an opening 111, and the aerosol-generating product 1000 may be received in the housing 10 through the opening 111 to be heated or removed from the housing 10.

The distal end 120 is provided with an air inlet 121, where the air inlet 121 is provided to supply outside air into the housing 10 during inhalation; and a charging interface 122, such as a USB type-C interface or a pin interface, for charging the aerosol generation device after being connected to an external power supply or an adapter.

Further, as shown in FIG. 1, the aerosol generation device 100 further includes:
a cavity 170, configured to accommodate or receive the aerosol-generating product 1000, where the aerosol-generating product 1000 may be removably received in the cavity 170 through the opening 111 during use;
a cell 130, configured to supply power, where the cell 130 is preferably a chargeable direct-current cell 130 and can be connected to an external power supply through the charging interface 122 for charging; and
a circuit board 140.

Further, as shown in FIG. 1, the aerosol generation device 100 further includes:
a plasma generator 20, configured to generate plasma and heat, using the plasma, the aerosol-generating product 1000 received in the cavity 170.

In the foregoing implementations, the physical term “plasma” is a mixture of electrons, ions, atoms, and atomic groups generated through the ionization of gas molecules when an applied voltage reaches a breakdown voltage.

In a preferred implementation, the plasma generator 20 is a generator that generates plasma by applying a breakdown voltage on a gas to discharge to break the gas down. The physical term “breakdown” indicates that a dielectric loses its dielectric property and becomes a conductor under the action of a sufficiently strong electric field; and a voltage that “breaks down” the dielectric is the “breakdown voltage”.

In physics, the “plasma” may be divided based on particle temperatures into equilibrium plasma (where an electron temperature is essentially equal to an ion temperature) and non-equilibrium plasma (where an electron temperature is much higher than an ion temperature). In a more preferred implementation, the plasma generated by the plasma generator 20 is non-equilibrium plasma. The physical term “non-equilibrium plasma” is low-temperature plasma with a low degree of ionization, where the electron temperature is much higher than the ion temperature. The non-equilibrium plasma is in a partially ionized state, where the electron temperature is usually of a few electron volts (1 eV=11600 K of corresponding energy), and a gas temperature (close to the ion temperature) is of a few hundred degrees Celsius.

In some preferred implementations, the plasma generator 20 is based on atmospheric-pressure glow discharge (APGD). The plasma generator 20 based on atmospheric-pressure glow discharge operates in an open environment with an operating gas of air at atmospheric pressure.

Further, as shown in FIG. 1, the plasma generator 20 is a generator that generates plasma by discharging to break air down. In FIG. 1, the plasma generator 20 includes:
an inlet 210, for air to enter the plasma generator 20, where the inlet 210 is connected to the air inlet 121 through an air channel 150, and the air can enter the plasma generator 20 through the air inlet 121 along an arrow R11 in the figure; and
an outlet 220, connected to the cavity 170 through a channel 160, for emitting or outputting the plasma along an arrow R2 in the figure during use to the aerosol-generating product 1000 in the cavity 170 through the channel 160, to heat the aerosol-generating product 1000.

In some implementations, there is no obstacle or barrier between the outlet 220 and the aerosol-generating product 1000, so that the plasma can be directly emitted or outputted or applied to the aerosol-generating product 1000. In this case, one part of the plasma can directly transfer thermal energy from the plasma gas to the aerosol-generating product 1000 for heating; and the other part of the plasma enables active particles (electrons, ions, free radicals, and the like) to undergo a series of physicochemical reactions with the aerosol-generating product 1000 to heat the aerosol-generating product 1000.

In an implementation, airflow channels are formed in the aerosol generation device 100 between the air inlet 121 and the opening 111, to jointly define an airflow path from the air inlet 121 to the opening 111 or the cavity 170 through the plasma generator 20. In addition, at least some of the airflow channels run through the plasma generator 20. Alternatively, at least some of the airflow channels are located in the plasma generator 20. Alternatively, the plasma generator 20 is at least partially exposed to the airflow channels.

Alternatively, as shown in FIG. 1, in another varying implementation, the aerosol generation device 100 further includes:
a gas source 30, configured to provide the plasma generator 20 with a gas that can generate plasma by discharge breakdown. In this varying embodiment, the gas stored in the gas source 30 and provided to the plasma generator 20 is helium, neon, or the like that is more stable than plasma generated by air breakdown. In use, the gas source 30 provides the gas to the plasma generator 20 through the air channel 150 along an arrow R12.

FIG. 2 is a schematic diagram of the plasma generator 20 according to an embodiment. In this embodiment, the plasma generator 20 includes:
a first electrode 21 and a second electrode 22 that are spaced apart, to form an electric field therebetween for discharging to break down air or the gas from the gas source 30.

In some implementations, a breakdown field formed between the first electrode 21 and the second electrode 22 is about 10-50 kV/cm; more preferably, the breakdown field formed between the first electrode 21 and the second electrode 22 is about 20-40 kV/cm; and more preferably, the breakdown field formed between the first electrode 21 and the second electrode 22 is 28-32 kV/cm.

In addition, in a more preferred implementation, the plasma generator 20 is based on micro hollow cathode discharge (MHCD) excited by high-voltage pulses; and in use, the high-voltage pulses are provided to the plasma generator 20, specifically to the first electrode 21 and the second electrode 22, for the plasma generator 20 to generate a pulsed electric field to generate plasma.

The first electrode 21 and the second electrode 22 are arranged substantially in parallel; and a spacing distance between the first electrode 21 and the second electrode 22 is greater than 10 μm and less than 2000 μm. More preferably, the spacing distance between the first electrode 21 and the second electrode 22 is 500-1500 μm; and more preferably, the spacing distance between the first electrode 21 and the second electrode 22 is 800-1200 μm. The spacing distance between the first electrode 21 and the second electrode 22 cannot be less than 5 μm.

In a preferred implementation shown in FIG. 2, the first electrode 21 and/or the second electrode 22 are/is a plate electrode, a coaxially arranged ring electrode, or the like.

Alternatively, the first electrode 21 and/or the second electrode 22 are/is thin. Further, the first electrode 21 and/or the second electrode 22 are/is in a shape of a thin sheet or plate. Alternatively, the first electrode 21 and/or the second electrode 22 have/has a length, a width, and a thickness; and the thickness of the first electrode 21 and/or the second electrode 22 is less than the length and the width.

In some preferred implementations, the first electrode 21 and/or the second electrode 22 have/has a thickness of about 0.05-0.5 mm; and more preferably, the first electrode 21 and/or the second electrode 22 have/has a thickness of about 0.1-0.3 mm.

In some preferred implementations, a distance between the first electrode 21 and/or the second electrode 22 is 0.1-0.8 mm; more preferably, the distance between the first electrode 21 and/or the second electrode 22 is 0.2-0.6 mm; and more preferably, the distance between the first electrode 21 and/or the second electrode 22 is 0.4-0.5 mm.

Alternatively, the first electrode 21 and/or the second electrode 22 are/is round or rectangular or curved or bowed or ring-shaped.

The first electrode 21 and/or the second electrode 22 are/is rigid. The material term “rigidity” is opposed to “flexibility”. Usually, the “rigidity” is the property of a material or object to be hard and not easily deformed, and is usually measured by using a physical parameter such as stiffness or modulus of elasticity.

The first electrode 21 and/or the second electrode 22 are/is arranged in parallel.

The first electrode 21 and/or the second electrode 22 may have the same shape or size.

Moreover, the first electrode 21 and/or the second electrode 22 are/is usually made of a low-resistivity material such as copper, gold, silver, platinum, or an alloy thereof.

The first electrode 21 and/or the second electrode 22 have/has resistivity of about 1×10⁻⁹-1×10⁻⁵ Ωm.

In some implementations, the first electrode 21 and the second electrode 22 in the plasma generator 20 are respectively connected to the circuit board 140 through wires.

In some more preferred embodiments, to inhibit the formation of discharge-to-arc transition between the first electrode 21 and the second electrode 22, an electrically insulating dielectric is deposited, sprayed, or formed on a surface of the first electrode 21 facing the second electrode 22 and/or a surface of the second electrode 22 facing the first electrode 21.

Alternatively, in the embodiment shown in FIG. 2, the plasma generator 20 further includes: at least one electrically insulating dielectric 23, which facilitates inhibiting discharge-to-arc transition, and maintaining discharge stability and uniformity.

In some optional implementations, the dielectric is made of a material with a dielectric constant much greater than that of air. Usually, taking the dielectric constant of air as 1, the dielectric may be selected from at least one of aluminum oxide, zirconium oxide, ceramic, glass, quartz, and an organic polymer such as polytetrafluoroethylene (PTFE) with the dielectric constant greater than or even much greater than that of air. Preferably, a dielectric constant of the dielectric is greater than 5; and more preferably, the dielectric constant of the dielectric is greater than 10.

Similarly, in some preferred implementations, the dielectric 23 is also in a shape of a thin sheet or plate. In some implementations, the dielectric 23 has a thickness of about 0.1-0.8 mm; more preferably, the dielectric 23 has a thickness of about 0.2-0.6 mm; and more preferably, the dielectric 23 has a thickness of about 0.4-0.5 mm.

Further, as shown in FIG. 2, the plasma generator 20 in this embodiment includes:
a fluid channel 24 extending between the inlet 210 and the outlet 220, for air to enter and for outputting plasma. In the embodiment shown in FIG. 2, the fluid channel 24 extends straight; and the fluid channel 24 is perpendicular to a thickness direction of the plasma generator 20.

The inlet 210 is formed on the first electrode 21; and the outlet 220 is formed on the second electrode 22.

In addition, in some preferred implementations, the fluid channel 24 has an inner diameter of about 0.1-0.9 mm. Alternatively, in a more preferred implementation, the fluid channel 24 has an inner diameter of about 0.2-0.8 mm. In a more preferred implementation, the fluid channel 24 has an inner diameter of about 0.4-0.6 mm.

Further, FIG. 3 is a schematic diagram of the plasma generator 20 according to another embodiment. In this embodiment, the plasma generator 20 includes:
a first electrode 21a and a second electrode 22a that are spaced apart;
at least one dielectric 23a or coating, located between the first electrode 21a and the second electrode 22a; and
a fluid channel 24a that curves and extends between an inlet 210a and an outlet 220a.

The fluid channel 24a at least partially extends parallel to the first electrode 21a and/or the second electrode 22a. In addition, the fluid channel 24a at least partially extends in the dielectric 23a.

Further, FIG. 4 is a schematic diagram of the plasma generator 20 according to another embodiment. In this embodiment, the plasma generator 20 includes:
a first electrode 21b and a second electrode 22b that are spaced apart; and
at least one dielectric or coating, located between the first electrode 21b and the second electrode 22b. Specifically, provided between the first electrode 21b and the second electrode 22b are:
a first dielectric or coating 231b, located between the first electrode 21b and the second electrode 22b, and substantially close to or bonded to a surface of the first electrode 21b facing the second electrode 22b; and
a second dielectric or coating 232b, located between the first electrode 21b and the second electrode 22b, and substantially close to or bonded to a surface of the second electrode 22b facing the first electrode 21b.

A distance space 25b is kept between the first dielectric or coating 231b and the second dielectric or coating 232b. The distance space 25b is sealed in a circumferential direction.

Further, according to FIG. 4, the plasma generator 20 further includes:
an inlet 210b provided on the first electrode 21b and an outlet 220b provided on the second electrode 22b; and a fluid channel 241b extending from the inlet 210b to the distance space 25b and a fluid channel 242b extending from the distance space 25b to the outlet 220b.

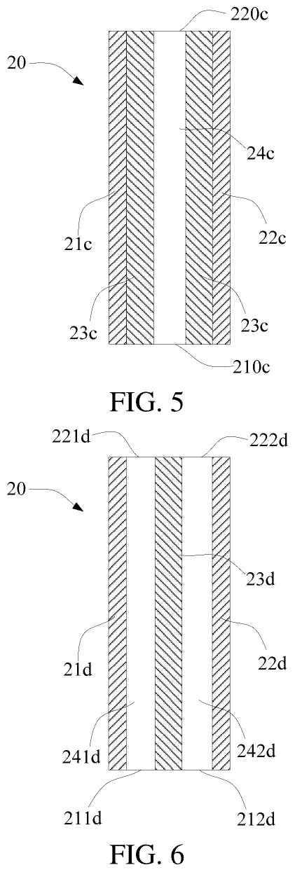

Alternatively, further, FIG. 5 is a schematic diagram of the plasma generator 20 according to another varying embodiment. In this embodiment, the plasma generator 20 includes:
a first electrode 21c and a second electrode 22c that are spaced apart, where the first electrode 21c and the second electrode 22c are thin sheets or plates arranged in a longitudinal direction;
a dielectric 23c, located between the first electrode 21c and the second electrode 22c, and parallel to the first electrode 21c and the second electrode 22c; and
a fluid channel 24c running through the dielectric 23c in the longitudinal direction, and an inlet 210c and an outlet 220c defined at both ends.

Alternatively, further, FIG. 6 is a schematic diagram of the plasma generator 20 according to another varying embodiment. In this embodiment, the plasma generator 20 includes:
a first electrode 21d and a second electrode 22d that are arranged in a longitudinal direction, where the first electrode 21d and the second electrode 22d are spaced apart from each other in a thickness direction perpendicular to the first electrode 21d and the second electrode 22d; and
a dielectric 23d arranged in the longitudinal direction and located between the first electrode 21d and the second electrode 22d. A fluid channel 241d extending in the longitudinal direction is defined and formed between the dielectric 23d and the first electrode 21d, and the fluid channel 241d has an inlet 211d and an outlet 221d that are opposite to each other in the longitudinal direction; and/or a fluid channel 242d extending in the longitudinal direction is defined and formed between the dielectric 23d and the second electrode 22d, and the fluid channel 242d has an inlet 212d and an outlet 222d that are opposite to each other in the longitudinal direction.

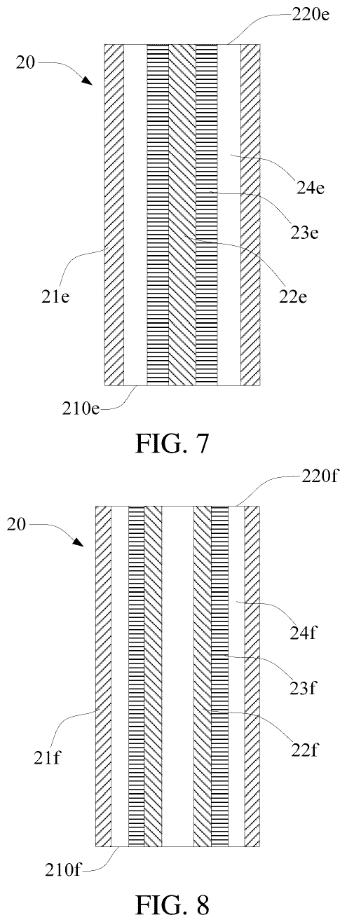

Alternatively, further, FIG. 7 is a schematic diagram of the plasma generator 20 according to another varying embodiment. In this embodiment, the plasma generator 20 includes:
a first electrode 21e and a second electrode 22e that extend in a longitudinal direction, where the first electrode 21e is in a shape of a tube surrounding the second electrode 22e; and the second electrode 22e is in a shape of a column extending in the longitudinal direction, or the like.

The first electrode 21e and the second electrode 22e are spaced apart; and a ring-shaped dielectric 23e surrounding the second electrode 22e exists between the first electrode 21e and the second electrode 22e.

A fluid channel 24e is defined and formed between the dielectric 23e and the first electrode 21e or between the dielectric 23e and the second electrode 22e; and the fluid channel 24e has an inlet 210e and an outlet 220e that are opposite to each other in the longitudinal direction.

Alternatively, further, FIG. 8 is a schematic diagram of the plasma generator 20 according to another varying embodiment. In this embodiment, the plasma generator 20 includes:
a tubular first electrode 21f and a tubular second electrode 22f that are coaxially arranged;
a tubular dielectric 23f located between the first electrode 21f and the second electrode 22f; and
a fluid channel 24f, formed between the dielectric 23f and the first electrode 21f and/or between the dielectric 23f and the second electrode 22f; and having an inlet 210f and an outlet 220f that are opposite to each other in a longitudinal direction.

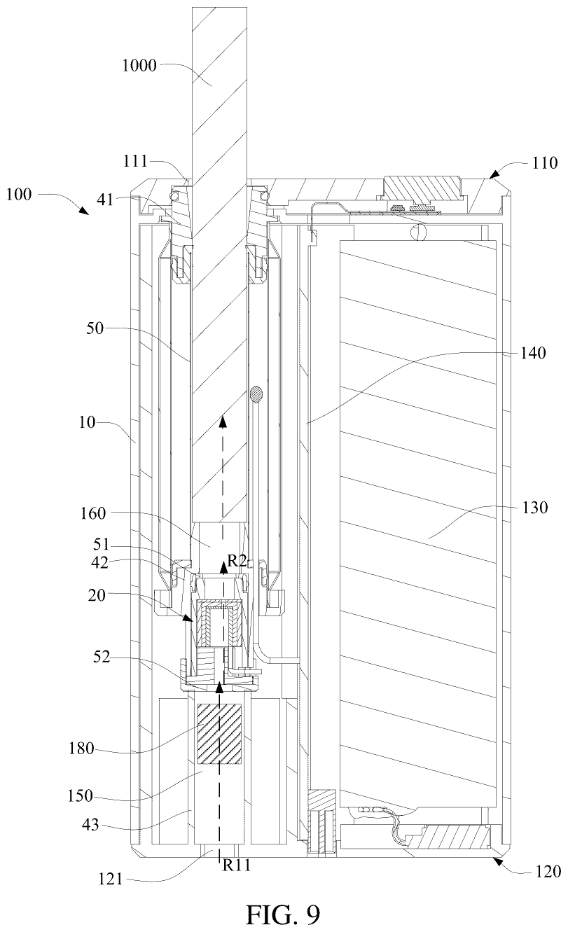

Further, FIG. 9 is a schematic diagram of the aerosol generation device 100 according to another specific embodiment. In this embodiment, the aerosol generation device 100 includes:
an outer shell 10, having a proximal end 110 and a distal end 120 that are opposite to each other in a longitudinal direction;
an opening 111 existing at the proximal end 110 and an air inlet 121 existing at the distal end 120;
a cell 130, configured to supply power; and
a circuit board 140 configured to control the operation of the aerosol generation device 100.

Further, a heating structure of the aerosol generation device 100 in FIG. 9 includes:
a tubular wall 50 extending in the longitudinal direction, defining a cavity for receiving or accommodating the aerosol-generating product 1000, where the tubular wall 50 has a first end close to the proximal end 110 in the longitudinal direction and a second end opposite to the first end;
an upper support 41, providing support at the first end of the tubular wall 50;
a lower support 42, providing support at the second end of the tubular wall 50;
a plasma generator 20, located between the tubular wall 50 and the distal end 120;
a support wall 43, roughly in a shape of a tube close to the distal end 120, to provide support to the plasma generator 20 at a position close to the distal end 120, where the support wall 43 defines an air channel 150 connecting the plasma generator 20 and the air inlet 121;
a channel 160 connecting the plasma generator 20 and the cavity in the tubular wall 50 and defined by the lower support 42;
a sealing element 51 such as a silicone ring or a silicone sleeve, located in a gap between the lower support 42 and the plasma generator 20 for sealing; and
a sealing element 52 such as a silicone ring or a silicone sleeve, located in a gap between the support wall 43 and the plasma generator 20 for sealing.

In use, outside air enters from the air inlet 121 along an arrow R11 in FIG. 9 to the plasma generator 20, and forms plasma through discharge breakdown. Then, the plasma is transferred or outputted along an arrow R2 to the aerosol-generating product 1000 for heating. In an implementation, the plasma generator 20 outputs the plasma in the longitudinal direction.

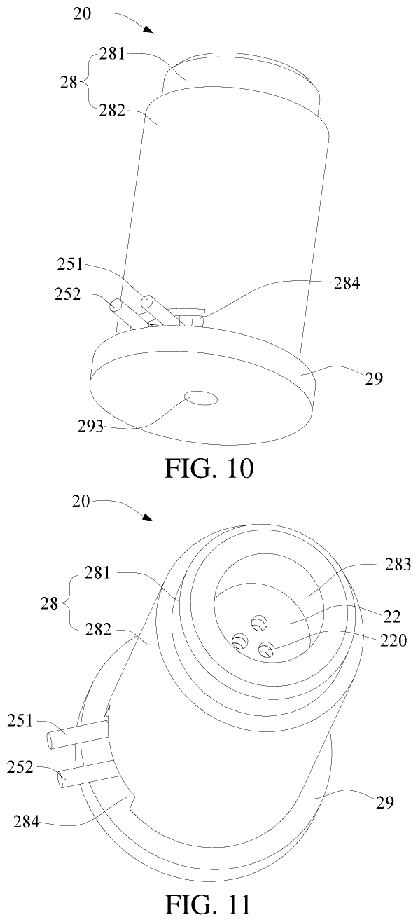

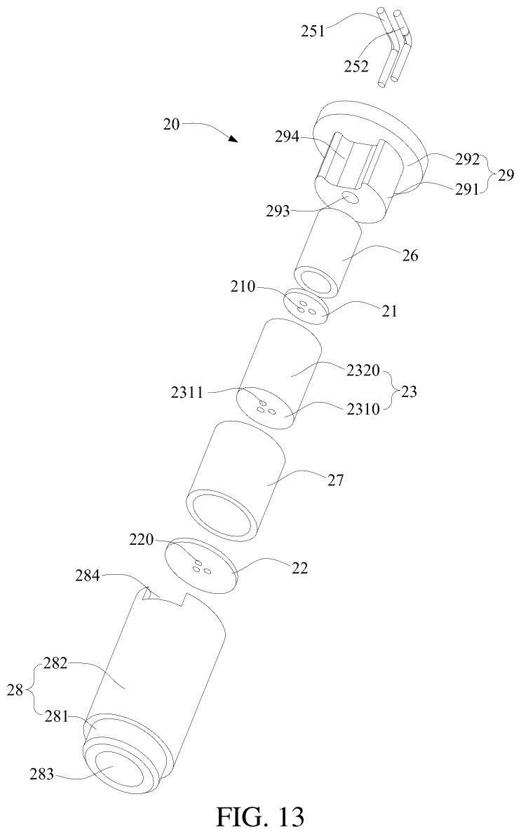

Further, FIG. 10 to FIG. 14 are schematic diagrams of the assembly and disassembly of components of the plasma generator 20 in FIG. 9. In this embodiment, the plasma generator 20 substantially extends in the longitudinal direction of the aerosol generation device 100, and is constructed to be in a longitudinally extending cylindrical shape.

An external member of the plasma generator 20 includes:
an outer cover 28 and an end cap 29, defining an outer surface of the plasma generator 20, and configured to encapsulate functional components of the plasma generator 20 inside, where the outer cover 28 is located at an upper end of the plasma generator 20 in the longitudinal direction, and the end cap 29 is located at a lower end.

The outer cover 28 is substantially of a tubular or cylindrical structure, and includes a section 281 and a section 282 that are arranged sequentially from the upper end to the lower end. A length of the section 281 is less than a length of the section 282, and an outer diameter of the section 281 is less than an outer diameter of the section 282, so that the section 281 and the section 282 form a step located on an outer surface of the outer cover 28. In assembly, the step is configured to reach into and against the lower support 42 for assembly and stopping.

The end cap 29 includes a section 291 and a section 292. An outer diameter of the section 291 is less than that of the section 292. In assembly, the section 291 extends into the section 282 of the outer cover 28, and the section 292 abuts against the lower end of the outer cover 28 for stopping.

In some implementations, the outer cover 28 and the end cap 29 are made of insulating ceramic or an organic polymer such as polytetrafluoroethylene, for electrical insulation and thermal insulation.

Further referring to FIG. 10 to FIG. 14, the outer cover 28 of the plasma generator 20 further includes:
a first electrode 21 and a second electrode 22 that are spaced apart in the longitudinal direction, where the first electrode 21 and the second electrode 22 are thin sheets or plates arranged perpendicular to the longitudinal direction of the plasma generator 20; the first electrode 21 and the second electrode 22 are round in the embodiment shown in the figures; and an outer diameter of the first electrode 21 is less than an outer diameter of the second electrode 22; and
a dielectric 23, constructed to be cylindrical, and having an end part 2310 perpendicular to the longitudinal direction and a peripheral part 2320 extending in the longitudinal direction, where the end part 2310 is located at an upper end of the peripheral part 2320.

After assembly, in the longitudinal direction, the end part 2310 is arranged between the first electrode 21 and the second electrode 22, to inhibit discharge-to-arc transition between the first electrode 21 and the second electrode 22; and A lower end of the peripheral part 2320 abuts against the section 291 of the end cap 29 for stopping.

Further referring to FIG. 10 to FIG. 14, the outer cover 28 of the plasma generator 20 further includes:
a ring-shaped first conducting element 26, extending between the end cap 29 and the first electrode 21 to provide support to the first electrode 21, where the first conducting element 26 abuts against the first electrode 21 to form a connection; and
a ring-shaped second conducting element 27, extending between the end cap 29 and the second electrode 22 to provide support to the second electrode 22, where the second conducting element 27 abuts against the second electrode 22 to form a connection. An inner diameter of the ring-shaped second conducting element 27 is greater than an outer diameter of the first conducting element 26, so that the second conducting element 27 surrounds the first conducting element 26 after assembly. After assembly, in a radial direction, the peripheral part 2320 of the dielectric 23 is located between the second conducting element 27 and the first conducting element 26, to provide support and insulation therebetween.

The first conducting element 26 and/or the second conducting element 27 are/is made of a low-resistivity conductor material respectively for facilitating power supply to the first electrode 21 and the second electrode 22.

Further referring to FIG. 10 to FIG. 14, the plasma generator 20 further includes:
a first conducting lead 251, connected to the first conducting element 26 by soldering or the like, and then connected to the circuit board 140; and
a second conducting lead 252, connected to the second conducting element 27 by soldering or the like, and then connected to the circuit board 140.

In an implementation, an impulse voltage can be provided to the first electrode 21 and the second electrode 22 through the first conducting lead 251 and the second conducting lead 252, so that an electric field that breaks down the air or gas to generate plasma is generated between the first electrode 21 and the second electrode 22.

In some other varying implementations, a direct-current voltage, an alternating-current voltage, or a radio-frequency voltage can be provided to the first electrode 21 and the second electrode 22 through the first conducting lead 251 and the second conducting lead 252, so that an electric field that breaks down the air or gas to generate plasma is generated between the first electrode 21 and the second electrode 22.

Further, to facilitate the first conducting lead 251 and the second conducting lead 252 to pass through the outer cover 28 from the outside for connection, as shown in FIG. 10 to FIG. 14, a notch 284 is provided at the lower end of the outer cover 28.

The first conducting lead 251 passes through the notch 284 into the outer cover 28 to be connected to the first conducting element 26; and the second conducting lead 252 extends through the notch 284 into the outer cover 28 to be connected to the second conducting element 27.

After assembly, the section 281 of the outer cover 28 has the inner diameter of the section 282, so that a step is formed therebetween on an inner wall of the outer cover 28; and a surface of the second electrode 22 facing away from the second conducting element 27 abuts against the step on the inner wall of the outer cover 28.

After assembly, the first electrode 21, the second electrode 22, the dielectric 23, the first conducting element 26, and the second conducting element 27 are all located in the section 282 of the outer cover 28, and are avoided from the section 281 of the outer cover 28.

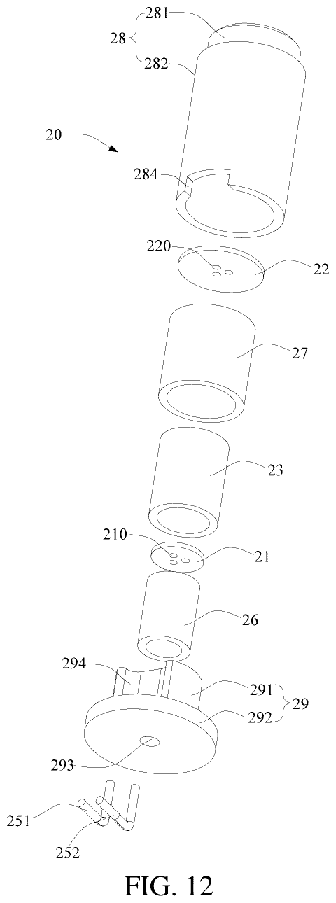

Further, as shown in FIG. 12 to FIG. 14, the design of the fluid channel of the plasma generator 20 includes the following parts arranged sequentially in the longitudinal direction of the plasma generator 20:

The end cap 29 has an axially through hole 293;
the first conducting element 26 has a hollow part;
the first electrode 21 is provided with an axially through hole 210;
the end part 2310 of the dielectric 23 is provided with a through hole 2311;
the second electrode 22 is provided with a through hole 220; and
the section 281 of the outer cover 28 has a hollow part 283.

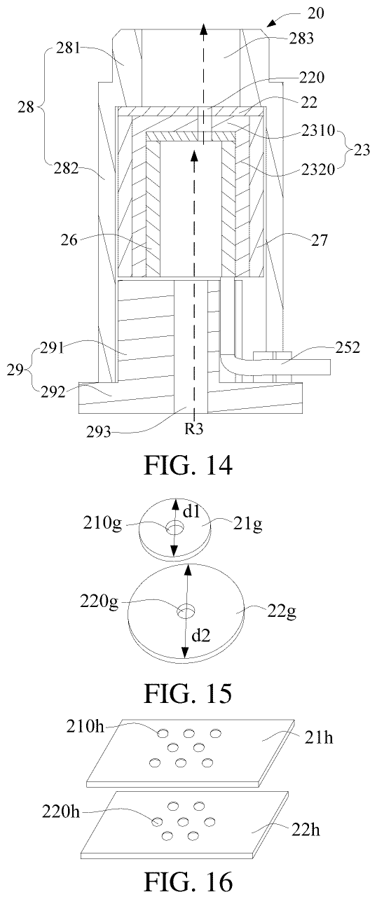

In use, as shown by an arrow R3 in FIG. 14, the foregoing parts are connected sequentially to form the fluid channel of the plasma generator 20, for air to enter between the first electrode 21 and the second electrode 22 to generate plasma through discharge breakdown, and then the plasma is transferred or outputted.

In the foregoing implementation, there are three holes 210 on the first electrode 21, three holes 2311 on the end part 2310 of the dielectric 23, and three holes 220 on the second electrode 22.

Alternatively, in some other implementations, there may be more or fewer of the foregoing holes. For example, FIG. 15 is a schematic diagram of a first electrode 21g with one hole 210g and a second electrode 22g with one hole 220g according to another embodiment. Alternatively, for example, FIG. 16 is a schematic diagram of a first electrode 21h with multiple holes 210h and a second electrode 22h with multiple holes 220h according to another embodiment.

In the foregoing implementation, the hole 210 on the first electrode 21, the hole 2311 on the end part 2310 of the dielectric 23, and the hole 220 on the second electrode 22 are aligned in the longitudinal direction of the plasma generator 20. Alternatively, in some other varying implementations, the foregoing holes are at least partially staggered, for example, as shown in FIG. 16, the holes 210h on the first electrode 21h and the holes 220h on the second electrode 22h that are at least partially staggered.

In the foregoing implementation, the first electrode 21 and the second electrode 22 are round. Alternatively, in some other varying implementations, the first electrode 21 and the second electrode 22 are in a rectangular, polygonal, or regular or non-regular geometrical shape.

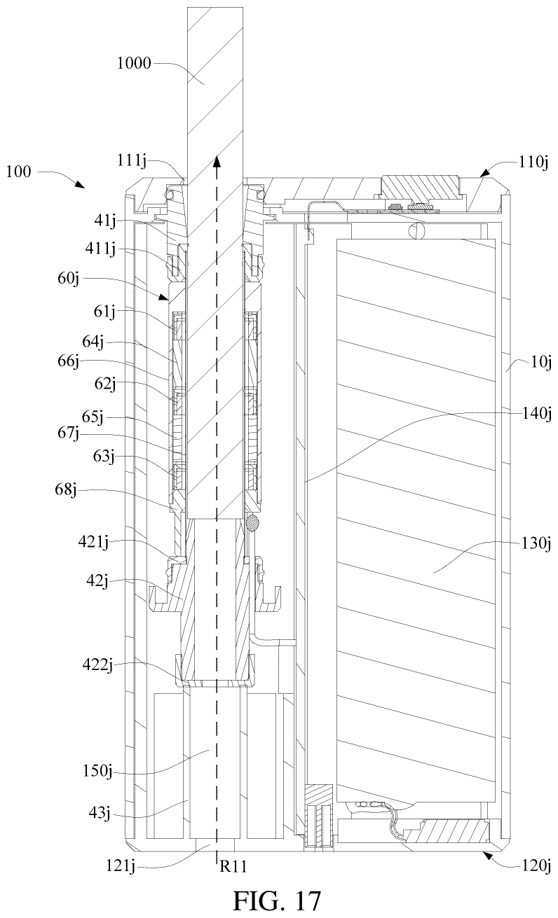

Further, FIG. 17 is a schematic diagram of the aerosol generation device 100 according to another specific embodiment. In this embodiment, the aerosol generation device 100 includes:
an outer shell 10j, having a proximal end 110j and a distal end 120j that are opposite to each other in a longitudinal direction;
an opening 111j existing at the proximal end 110j and an air inlet 121j existing at the distal end 120j;
a cell 130j, configured to supply power; and
a circuit board 140j configured to control the operation of the aerosol generation device 100.

Further, a heating structure of the aerosol generation device 100 in FIG. 17 includes:
a plasma heating mechanism 60j, constructed to be in a shape of a tube or cylinder extending in the longitudinal direction of the outer shell 10j. A cavity extending in the longitudinal direction is defined in the plasma heating mechanism 60j, to accommodate and receive the aerosol-generating product 1000. In use, the plasma heating mechanism 60j surrounds the aerosol-generating product 1000 and emits or transfers plasma from the periphery to the aerosol-generating product 1000 for heating.

Further, in FIG. 17,
an upper support 41j provides support to the plasma heating mechanism 60j at a position close to the proximal end 110j;
a lower support 42j provides support to the plasma heating mechanism 60j at an end part of the plasma heating mechanism 60j close to the distal end 120j; and
a support wall 43j provides support to the lower support 42j at the distal end 120j.

A sealing element 411j such as a silicone ring or a silicone sleeve is located between the upper support 41j and the plasma heating mechanism 60j for sealing therebetween;
a sealing element 421j such as a silicone ring or a silicone sleeve is located between the lower support 42j and the plasma heating mechanism 60j for sealing therebetween; and
a sealing element 422j such as a silicone ring or a silicone sleeve is located between the support wall 43j and the lower support 42j for sealing therebetween.

In use, an air channel 150j in the support wall 43j and a hole in the lower support 42j define and form an airflow channel extending from the air inlet 121j to the plasma heating mechanism 60j.

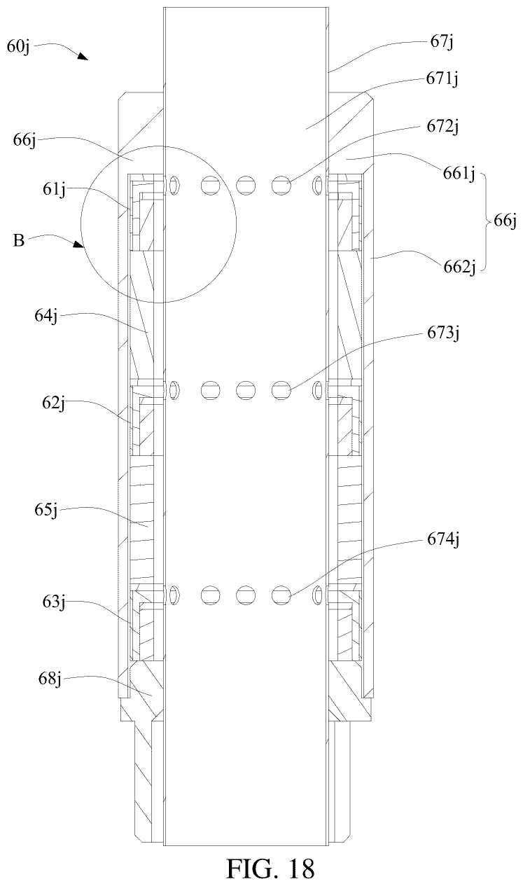

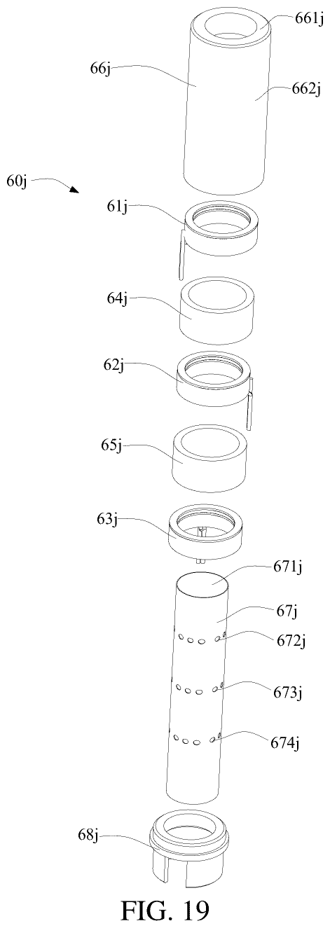

Further referring to FIG. 18 and FIG. 19, the plasma heating mechanism 60j specifically includes the following components:
a substrate 67j substantially in a tubular shape, where the tubular substrate 67j is at least partially constructed to surround and define a cavity 671j for receiving or accommodating the aerosol-generating product 1000; and
at least one or more plasma generators arranged at least partially around the substrate 67j, configured to generate and emit plasma. Specifically, in this embodiment, the plasma heating mechanism 60j includes a first plasma generator 61j, a second plasma generator 62j, and a third plasma generator 63j that are spaced apart sequentially in the longitudinal direction. The multiple plasma generators are each independently connected to the circuit board 140j and independently controlled by the circuit board 140j, to independently generate and emit plasma to independently heat different parts of the aerosol-generating product 1000.

Further, in some other optional implementations, the first plasma generator 61j, the second plasma generator 62j, and the third plasma generator 63j sequentially start heating, that is, start heating one after the other.

Further, in some other optional implementations, the first plasma generator 61j, the second plasma generator 62j, and the third plasma generator 63j respectively heat different parts of the aerosol-generating product 1000 according to different target or preset temperatures, to heat the different parts of the aerosol-generating product 1000 to the different temperatures.

Further referring to FIG. 18 and FIG. 19, the plasma heating mechanism 60j further includes:
at least one mechanical isolator, disposed between two adjacent plasma generators.

The at least one mechanical isolator is arranged to provide support to the adjacent plasma generators.

The at least one mechanical isolator is arranged to keep a distance between the adjacent plasma generators.

The at least one mechanical isolator is an insulator or an insulating material, and then is further arranged for providing insulation between the adjacent plasma generators in the longitudinal direction.

Specifically, in this embodiment, the plasma heating mechanism 60j includes a mechanical isolator 64j and a mechanical isolator 65j that are spaced apart sequentially in the longitudinal direction. The mechanical isolator 64j is arranged between the first plasma generator 61j and the second plasma generator 62j in the longitudinal direction. The mechanical isolator 65j is arranged between the second plasma generator 62j and the third plasma generator 63j in the longitudinal direction. The mechanical isolator 64j and the mechanical isolator 65j are in a shape of a ring or tube.

Further referring to FIG. 18 and FIG. 19, the plasma heating mechanism 60j further includes:
an outer cover 66j and an end cap 68j, defining an outer surface of the plasma heating mechanism 60j, and surrounding, accommodating, and holding the plasma generator and the mechanical isolator. The outer cover 66j and the end cap 68j wrap the plasma generator from the outside, and provide external electrical insulation and thermal insulation.

The outer cover 66j and the end cap 68j are preferably made of an insulating organic polymer, such as polycarbonate, polytetrafluoroethylene, or polypropylene.

The outer cover 66j includes an endwall 661j at an upper end and a peripheral wall 662j extending from the endwall 661j. In assembly, the peripheral wall 662j abuts against the end cap 68j for stopping. The endwall 661j of the outer cover 66j blocks and fastens the plasma generator from the upper end.

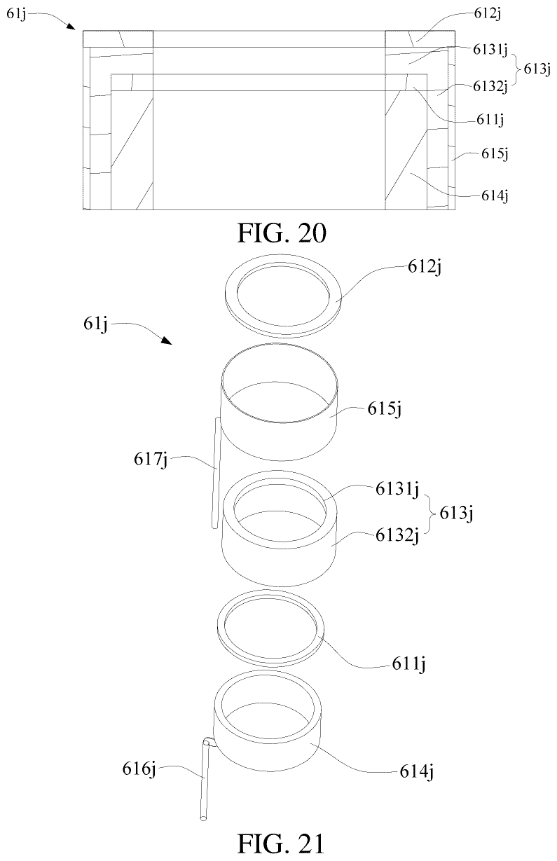

The plasma generator 61j/62j/63j is in a ring shape. For a specific structure, further refer to FIG. 20 and FIG. 21. A structure of the first plasma generator 61j includes:
a first electrode 611j and a second electrode 612j that are spaced apart sequentially in the longitudinal direction, where the first electrode 611j and the second electrode 612j are in a ring shape, and surround the substrate 67j and/or the aerosol-generating product 1000;
a first conducting element 614j, in a ring shape, arranged coaxially with the first electrode 611j, and providing support to the first electrode 611j, where the first conducting element 614j is in contact with the first electrode 611j to be connected;
a second conducting element 615j, in a ring shape, surrounding the first conducting element 614j, arranged coaxially with the second electrode 612j, and providing support to the second electrode 612j, where the second conducting element 615j is in contact with the second electrode 612j to be connected; and
a dielectric 613j, constructed to be cylindrical, and having an end part 6130j perpendicular to the longitudinal direction and a peripheral part 6132j extending in the longitudinal direction, where the end part 6130j is located at an upper end of the peripheral part 6132j. After assembly, in the longitudinal direction, the end part 6130j is arranged between the first electrode 611j and the second electrode 612j, to inhibit discharge-to-arc transition between the first electrode 611j and the second electrode 612j; and in a radial direction, the peripheral part 6132j is located between the first conducting element 614j and the second conducting element 615j, to provide support and insulation therebetween.

A first conducting lead 616j is connected to the first conducting element 614j by soldering or the like, and is then connected to the circuit board 140j; and
a second conducting lead 617j is connected to the second conducting element 615j by soldering or the like, and is then connected to the circuit board 140j.

In an implementation, an impulse voltage can be provided to the first electrode 611j and the second electrode 612j through the first conducting lead 616j and the second conducting lead 617j, so that an electric field that breaks down the air or gas to generate plasma is generated between the first electrode 611j and the second electrode 612j.

Similarly, the outer cover 66j and/or the end cap 68j are/is provided with a notch or window or hole or the like, for the first conducting lead 616j and the second conducting lead 617j to extend from the outer cover 66j and/or the end cap 68j to the outside, to facilitate connection to the circuit board 140j.

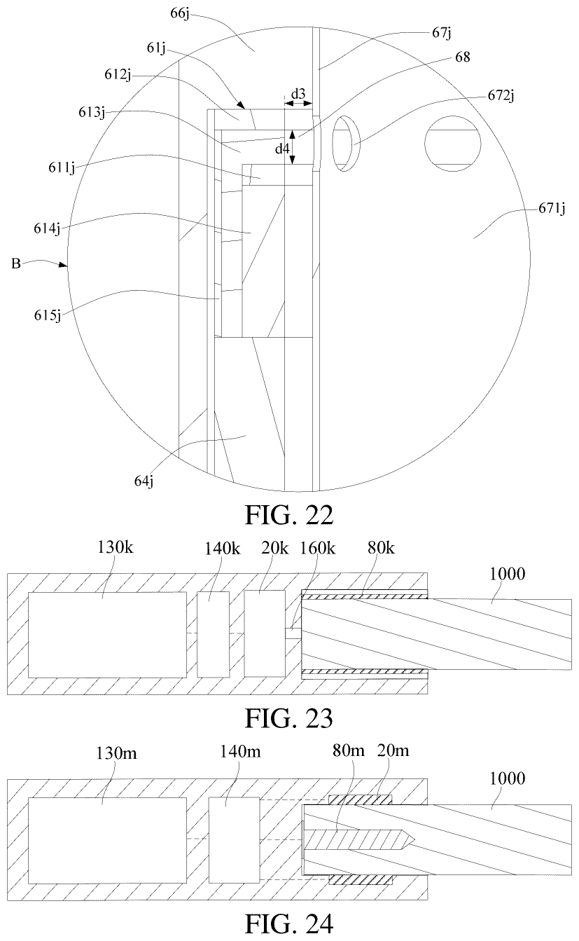

Further, in a preferred embodiment shown in FIG. 22, the substrate 67j is not in contact with the first plasma generator 61j/62j/63j. Specifically, for example, a gap d3 is kept between the substrate 67j and the first plasma generator 61j, and the gap d3 is less than 1 mm, about 0.3-0.8 mm. According to an aspect, the first plasma generator 61j is kept insulated from the substrate 67j through the gap d3. According to another aspect, the gap d3 between the first plasma generator 61j and the substrate 67j is filled with air as an operating gas for discharge breakdown by the first plasma generator 61j.

Further, as shown in FIG. 22, the size of the gap d3 is substantially close to that of a gap d4 between the first electrode 611j and the second electrode 612j. The size of the gap d3 is about 0.6-1.5 times that of the gap d4.

Further, in a preferred implementation, the substrate 67j is provided with a radially through hole 672j/673j/674j, for at least partial plasma generated by the plasma generator 61j/62j/63j to passes through the hole 672j/673j/674j to be directly provided to the aerosol-generating product 1000 in the cavity 671j for heating.

In a preferred implementation shown in FIG. 22, the hole 672j is opposite to or aligned with the gap d4 between the first electrode 611j and the second electrode 612j in the radial direction, which facilitates increasing plasma transfer efficiency.

In the foregoing embodiment, there is substantially no obstacle that can block the plasma on plasma transfer and emission paths between the plasma generator 61j/62j/63j and the aerosol-generating product 1000, which increases plasma utilization efficiency as much as possible.

Further, in another varying implementation, there is a substrate that blocks or obscures plasma on plasma transfer and emission paths between the plasma generator and the aerosol-generating product 1000. In this varying implementation, the substrate is preferably made of a metal or an alloy with high thermal conductivity, such as silver, copper, aluminum, or an alloy thereof. In an implementation, the plasma generator emits and provides plasma to the substrate to heat the substrate, and then the heated substrate heats the aerosol-generating product 1000 in contact with the substrate to generate an aerosol. Preferably, the substrate 67j for indirectly heating the aerosol-generating product 1000 has thermal conductivity greater than 40 W/mK, such as stainless steel with thermal conductivity of 41.9-58.6 W/mK, an aluminum alloy with thermal conductivity of 121-151 W/mK, and brass or pure copper with thermal conductivity greater than 100 W/mK.

Similarly, the hole 672j/673j/674j of the substrate 67j can be further provided for plasma to pass through and then directly heat the aerosol-generating product. In this case, in operation, the plasma can partially be directly outputted to the aerosol-generating product 1000 for direct heating, and partially be outputted to the substrate 67j to indirectly heat the aerosol-generating product 1000, which is conducive to heat homogenization.

For example, in a specific varying embodiment, the substrate 67j is constructed to be in a shape of a tube without a hole on a tube wall, so that an outer surface of the substrate 67j is closed in a length direction, and then the outer surface of the substrate 67j receives the plasma emitted by the plasma generator 61j/62j/63j to emit heat and then receives the aerosol-generating product 1000 inside.

In the foregoing implementation, the plasma generator heats the substrate to indirectly heat aerosol-generating product 1000; and the substrate may be in any shape or of any structure.

Alternatively, in more varying implementations, the aerosol generation device further includes:
a heating element, to heat the aerosol-generating product outside the plasma generator.

For example, FIG. 23 is a schematic diagram of an aerosol generation device according to an embodiment. The aerosol generation device includes:
a cell 130k and a circuit board 140k;
a plasma generator 20k, configured to provide plasma to the aerosol-generating product 1000 in a longitudinal direction for heating; and
a heating element 80k, surrounding the aerosol-generating product 1000 in a circumferential direction to heat the aerosol-generating product 1000 from the periphery of the aerosol-generating product 1000.

In addition, the aerosol generation device further includes a channel 160k between the plasma generator 20k and the aerosol-generating product 1000 in the longitudinal direction, to transfer plasma.

In some implementations, the heating element 80k is a resistance heating element based on Joule heating, or an electromagnetic induction heating element that emits heat by being penetrated by a varying magnetic field, or an infrared heating element that heats the aerosol-generating product 1000 by radiating an infrared ray, or a microwave heating element that heats the aerosol-generating product 1000 by emitting microwaves.

Alternatively, FIG. 24 is a schematic diagram of an aerosol generation device according to another varying embodiment. The aerosol generation device includes:
a cell 130m and a circuit board 140m;
a plasma generator 20m, surrounding the aerosol-generating product 1000 in a circumferential direction to emit plasma to the aerosol-generating product 1000 from the periphery for heating; and
a heating element 80m, in a shape of a pin or needle, and at least partially inserted into the aerosol-generating product 1000 for heating. The heating element 80m may be at least one of a resistance heating element, an electromagnetic induction heating element, an infrared heating element, and a microwave heating element.

Alternatively, further, FIG. 29 is a schematic diagram of a plasma generator 20n according to another varying embodiment. The plasma generator 20n includes:
one first electrode 21n; and
multiple or several second electrodes 22n spaced apart from the first electrode 21n.

Each second electrode 22n corresponds to a part of the first electrode 21n in a longitudinal direction.

In an implementation, the first electrode 21n is connected to a positive output end of the circuit board 140 through a wire, and each of the multiple or several second electrodes 22n is connected to a negative end of the circuit board 140 through a wire. In this case, when an impulse voltage is provided to the electrodes, multiple or several breakdown fields are formed between the first electrode and the second electrodes, to break down air to generate plasma.

In some other varying implementations, a direct-current voltage, an alternating-current voltage, a radio-frequency voltage, or the like is provided to the plasma generator 20n, for the plasma generator 20n to generate an electric field to break the air or gas down to generate plasma.

In an implementation shown in FIG. 29, the first electrode 21n and/or the second electrode 22n are/is provided with holes to form inlets for air to enter or outlets for outputting plasma.

In an implementation shown in FIG. 29, the multiple or several second electrodes 22n are connected in sequence. Alternatively, in more varying implementations, the multiple or several second electrodes 22n are arranged in a matrix or array.

Certainly, a dielectric is provided between the first electrode 21n and the second electrode 22n, and/or a dielectric coating is formed on surfaces of the first electrode 21n and the second electrode 22n.

Alternatively, further, FIG. 30 is a schematic diagram of a plasma generator 20p according to another varying embodiment. The plasma generator 20p includes:
multiple first electrodes 21p; and
multiple second electrodes 22p.

One of the multiple first electrodes 21p corresponds to one of the multiple second electrodes 22p, to form multiple electrode pairs that form breakdown fields.

The multiple first electrodes 21p and the multiple second electrodes 22p may be arranged in an array or in a matrix, or arranged dispersedly.

Alternatively, in some other varying implementations, in the plasma generator, one of the first electrodes can correspond to one or more of the second electrodes, to form one or more electrode pairs; or one of the second electrodes corresponds to one or more of the first electrodes, to form one or more electrode pairs.

Further, in some implementations, the circuit board 140 controls the plasma generator 20 to provide a high-frequency and high-voltage impulse voltage to the first electrode 21 and the second electrode 22, for the plasma generator 20 to generate non-equilibrium plasma through atmospheric-pressure glow discharge.

In some implementations, frequency of the impulse voltage provided to the first electrode 21 and the second electrode 22 is 1-100 kHz; preferably, the frequency of the impulse voltage is 5-50 kHz; and more preferably, the frequency of the impulse voltage is 10-20 kHz.

In some implementations, a voltage amplitude of the impulse voltage provided to the first electrode 21 and the second electrode 22 is 1-9 kV; preferably, the voltage amplitude of the impulse voltage is 2-7 kV; and more preferably, the voltage amplitude of the impulse voltage is 3-5 kV.

In some implementations, an impulse width of the impulse voltage provided to the first electrode 21 and the second electrode 22 is 10-600 ns; preferably, the impulse width of the impulse voltage is 50-500 ns; and more preferably, the impulse width of the impulse voltage is 100-200 ns.

In a specific implementation, the amplitude of the impulse voltage is about 3 kV, the frequency is about 80 kHz, and the impulse width is about 200 ns.

In a specific implementation, when the impulse voltage is provided to the plasma generator 20 in the embodiment shown in FIG. 9, the plasma generator 20 generates plasma generated through dielectric barrier discharge (DBD) in air at atmospheric pressure. Further, electrons e in the plasma are measured by using a Langmuir probe, which are about 10¹⁰/(cm³)-10¹³/(cm³); and in more specific detections, the electrons e are about 10¹¹/(cm³)-10¹²/(cm³). In addition, other active groups in the plasma are further measured by spectroscopy. From spectroscopy results, active ions contained in the plasma mainly include oxygen atoms O, excited-state nitrogen molecules N₂, ozone molecules O₃, hydroxyl groups OH, oxygen ions, nitrogen ions, and nitrogen oxide molecules NOx.

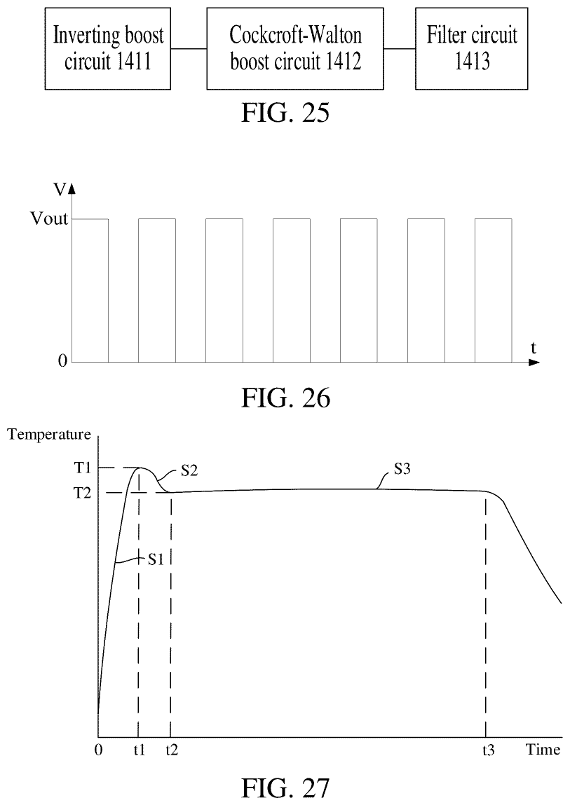

Further, FIG. 25 is a block diagram of circuits of the circuit board 140 according to an embodiment, and FIG. 26 is a schematic diagram of an impulse voltage provided by the circuit board 140 to the first electrode 21 and the second electrode 22. Specifically, the circuit board 140 shown in FIG. 25 includes the following circuits:

An inverting boost circuit 1411 performs a first inverting boost on a direct-current voltage outputted by the cell 130. In some specific implementations, the voltage outputted by the cell 130 is 3.7-9.0 V; and the inverting boost circuit 1411 can process the voltage outputted by the cell 130 to form an alternating current with an amplitude tens of times greater. In some specific implementations, the inverting boost circuit 1411 may be a commonly used series or parallel LC oscillation circuit, or a purchased inverting boost IC, such as an inverting boost IC with a model of MAX774ESA+T from “Hengnuo core technology”, an inverting boost IC with a model of SN74HCT14N from “Ruixin Bochuang electronics”, or an inverting boost IC with a model of SN74LVC1G38DCKR from “Dejie Xincheng technology”, or another IC that can achieve the same inverting boost function.

A Cockcroft-Walton boost circuit 1412 is configured to perform a further boost on an alternating voltage outputted by the inverting boost circuit 1411, with a boost factor adjustable in the range of tens to hundreds of times, so that the amplitude of the output voltage meets the requirement for the plasma generator 20 to generate an electric field that breaks air down. The electrical term “Cockcroft-Walton boost circuit” is a voltage doubling circuit commonly used in the electrical field, and can perform a doubling boost and AC/DC conversion.

A filter circuit 1413 filters an output voltage with an amplitude on the order of kilovolts after boosting by the Cockcroft-Walton boost circuit 1412, to obtain the high-frequency and high-voltage impulse voltage that meets the foregoing requirement shown in FIG. 26 to be provided to the plasma generator 20. The filter circuit 1413 may include a high-order filter, or a similar filter circuit, or the like.

Further, in a preferred implementation, the circuit board 140 controls the amplitude and frequency of the high-frequency and high-voltage impulse voltage provided to the plasma generator 20 to be variable.

In some implementations, the circuit board 140 provides high-voltage pulses to the plasma generator 20, for the plasma generator 20 to pulsedly or intermittently generate a breakdown field, and to pulsedly or intermittently discharge to break a gas down, to generate plasma, so that the aerosol-generating product 1000 can be stably heated or cooled.

For example, FIG. 27 is a schematic diagram of a heating curve of the aerosol-generating product 1000 within predetermined time according to an embodiment. In the heating process, the circuit board 140 controls the impulse voltage provided to the plasma generator 20 based on a required target temperature. In some implementations, the heating curve is within predetermined time, and the predetermined time is set based on the amount of aerosols that can be generated by the aerosol-generating product 1000, and the smoking duration (for example, 4 min) acceptable to users. For example, the heating curve in FIG. 27 includes the following heating process:

First stage S1: quickly heating from room temperature to a first preset temperature T1 within time t1 for preheating.

Second stage S2: cooling down from the first preset temperature T1 to a second preset temperature T2 within time t2.

Third stage S3: maintaining the heating temperature substantially at the preset temperature T2 until time t3, for the aerosol-generating product 1000 to be stably heated at the second preset temperature T2 to generate an aerosol for inhalation; and stopping providing power to a heater 30 after inhalation to naturally cool down the heater 30.

Correspondingly, the circuit board 140 controls the amplitude of the impulse voltage provided to the plasma generator 20 to be greater in the first stage S1 than in the second stage S2 and/or the third stage S3. Alternatively, in some implementations, the circuit board 140 controls the amplitude of the impulse voltage provided to the plasma generator 20 to be substantially constant, while the frequency and/or impulse width are/is variable within predetermined time. Alternatively, in some other implementations, the circuit board 140 controls the frequency and/or impulse width of the impulse voltage provided to the plasma generator 20 to be substantially constant, while the amplitude of the impulse voltage is variable, so that the heating temperature of the aerosol-generating product 1000 is maintained at the required target temperature.

Alternatively, further referring to the embodiment shown in FIG. 9, in another varying implementation, the aerosol generation device provides air stably to the inlet of the plasma generator 20 by using an air pump 180, to be used as a gas source for breakdown. In a preferred implementation in FIG. 9, the air pump 180 may be preferably located between the air inlet 121 of the housing 10 and the inlet of the plasma generator 20.

Further, the air pump 180 is controlled by the circuit board 140.

In some specific implementations, under the control of the circuit board 140, the air pump 180 operates with the plasma generator 20 at the same time. For example, in an implementation, when a user is smoking, the circuit board 140 controls the air pump 180 to start to provide air stably to the inlet of the plasma generator 20, and starts the plasma generator 20 at the same time to generate plasma to be provided to the aerosol-generating product 1000. When the user stops smoking or the user is not smoking, the air pump 180 is prevented from starting, and the plasma generator 20 is prevented from generating plasma.

In some other implementations, the circuit board 140 determines a smoking action of the user by using a sensing device such as an airflow sensor, to control the air pump 180 and the plasma generator 20 to start based on the sensed smoking action.

Alternatively, in some other varying implementations, the circuit board 140 controls the air pump 180 to start or stop, to adjust the heating temperature of the aerosol-generating product 1000. For example, when a user is smoking, the circuit board 140 controls the air pump 180 to start or to increase the amount of air pumped; while when the user is not smoking, the circuit board 140 controls the air pump 180 to stop or to reduce the amount of air pumped by the air pump 180. Alternatively, in some other implementations, based on the heating process of the aerosol-generating product 1000 in FIG. 27, in the third stage S3 in which the heating temperature is maintained substantially constant, the circuit board 140 controls the air pump 180 to operate at a smaller amount of air pumped than that when smoking, for air at a low flow rate or reduced air to pass through in the constant-temperature stage, which facilitates maintaining the heating temperature of the aerosol-generating product 1000 constant.

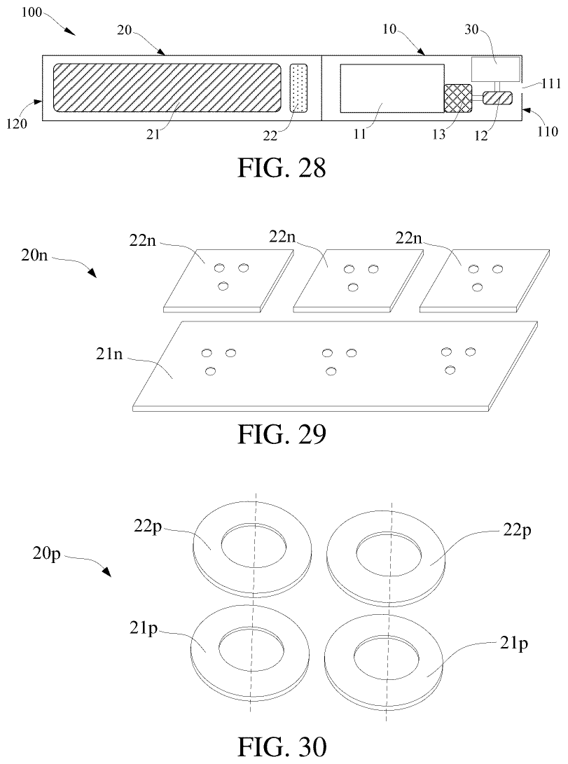

Further, FIG. 28 is a schematic diagram of an electronic atomization device according to an embodiment. The electronic atomization device is configured to atomize a liquid substrate to generate an aerosol for inhalation. The electronic atomization device 100 in this disclosure may also be represented as an aerosol generation system or a drug delivery product. Therefore, this device 100 or system may be adapted to provide one or more substances (such as flavor agents and/or active pharmaceutical ingredients) in an inhalable form or state. For example, the inhalable substance may be substantially in an aerosol form (that is, fine solid particles or suspension droplets in a gas).

FIG. 28 is a schematic diagram of a structure of the electronic atomization device 100 according to an embodiment. The device usually includes several components disposed in an external body or outer shell (which may be referred to as a housing). The overall design of the external body or outer shell may vary, and the type or configuration of the external body that may limit the overall size and shape of the electronic atomization device 100 may vary. Usually, an elongated body similar to the shape of a cigarette or cigar may be formed from a single integrated housing, or an elongated housing may be formed from two or more separable bodies. For example, the electronic atomization device 100 may have a control body at one end, where the control body has a housing including one or more reusable components (for example, batteries such as rechargeable batteries and/or rechargeable supercapacitors, and various electronic devices for controlling operations of the product); and at the other end, may have an external body or outer shell that can be removably coupled and includes disposable parts (for example, a disposable flavor-containing cartridge).

Specifically, further referring to FIG. 28, the electronic atomization device 100 includes an atomizer 10 that stores a liquid substrate and atomizes the liquid substrate to generate an aerosol, and a power supply mechanism 20 that supplies power to the atomizer 10. The power supply mechanism 20 and the atomizer 10 are detachably aligned based on a functional relationship. The atomizer 10 may be connected to the power supply mechanism 20 by using various structures, to generate a threaded connection, a press-fit connection, an interference fit, a magnetic connection, and the like. In some exemplary implementations, when the atomizer 10 and the power supply mechanism 20 are in an assembled configuration, the electronic atomization device 100 may be substantially in a rod shape, a flat-cylinder shape, a bar shape, a column shape, or the like.

In an optional implementation, the power supply mechanism 20 and the atomizer 10 may include separate housings or external bodies that may be made of any of different materials. The housing may be made of any suitable and structurally intact material. In some examples, the housing may be made of a metal or an alloy such as stainless steel or aluminum. Other suitable materials include various plastics (for example, polycarbonate), metal-plating over plastics, ceramics, and the like.

Further, as shown in FIG. 28, the electronic atomization device 100 has a proximal end 110 and a distal end 120 opposite to each other in a length direction. In use, the proximal end 110 is usually used as the end for a user to smoke, and the distal end 120 is the end away from the user. The atomizer 10 is arranged at the proximal end, and the power supply mechanism 20 is arranged at the distal end 120.

According to FIG. 28, the power supply mechanism 20 includes:
a cell 21, configured to supply power, where the cell 21 may include, for example, a battery (disposable or rechargeable), a rechargeable supercapacitor, a rechargeable solid-state battery (SSB), a rechargeable lithium-ion battery (LiB), or a combination thereof; and
a circuit board 22, configured to guide a current between the cell 21 and the atomizer 10.

As shown in FIG. 28, the atomizer 10 includes:
a suction nozzle 111 located at the proximal end 110, for a user to smoke;
a liquid storage cavity 11, configured to store the liquid substrate;
a capillary element 12, configured to adsorb and hold the liquid substrate;
a liquid transfer element 13, to transfer the liquid substrate between the liquid storage cavity 11 and the capillary element 12; and
a plasma generator 30, configured to provide plasma to the capillary element 12 to at least partially heat and atomize the liquid substrate in the capillary element 12 through plasma heating to generate the aerosol to be outputted to the suction nozzle 111.

In some specific implementations, the capillary element 12 is, for example, a porous body made of cellucotton, porous ceramic, porous glass, or foam metal, or a capillary tube.

In an optional implementation, the liquid transfer element 13 may be a micro-pump to pump a predetermined amount of liquid substrate from the liquid storage cavity 11 to the capillary element 12; and a suitable micro-pump is, for example, a micro-pump based on the micro electro mechanical system (MEMS) technology. Examples of the suitable micro-pump include a micro-pump with the model MDP2205 from thinXXS Microtechnology AG, micro-pumps with the models mp5 and mp6 from Bartels Mikrotechnik GmbH, a piezoelectric micro-pump from Takasago Fluidic Systems, and other micro-pumps.

Further, the circuit board 22 includes several electronic components, and in some examples, may be formed on a printed circuit board (PCB) that supports and electrically connects the electronic components. The electronic components may include a microprocessor or processor core, and a memory. In some examples, a control component may include a microcontroller having an integrated processor core and memory, and may further include one or more integrated input/output peripherals. The circuit board 22 is configured to provide required high-voltage pulses to the plasma generator 30, for the plasma generator to break air down through discharge to generate plasma. The plasma generator 30 is constructed as described in the foregoing embodiment.

It needs to be noted that the specification and the accompanying drawings of this application provide preferred embodiments of this application, but are not limited to the embodiments described in this specification. Further, a person of ordinary skill in the art may make improvements or modifications according to the foregoing descriptions, and all the improvements and modifications shall fall within the protection scope of the appended claims of this application.

1-75. (canceled)

76. An aerosol generation device, configured to heat an aerosol-generating product to generate an aerosol, comprising:
a plasma generator, configured to generate plasma to heat the aerosol-generating product through the plasma.

77. The aerosol generation device according to claim 76, wherein the plasma is constructed to be generated by applying a breakdown voltage to a gas to break the gas down.

78. The aerosol generation device according to claim 77, wherein the gas comprises at least one of air, helium, and neon.

79. The aerosol generation device according to claim 76, wherein electrons in the plasma generated by the plasma generator are 10¹⁰/cm³-10¹³/cm³.

80. The aerosol generation device according to claim 76, wherein the plasma generator comprises a first electrode and a second electrode that are spaced apart, to form a breakdown field between the first electrode and the second electrode to break the gas down to generate the plasma.

81. The aerosol generation device according to claim 80, wherein the breakdown field is 10-50 kV/cm.

82. The aerosol generation device according to claim 80, wherein a spacing distance between the first electrode and the second electrode is 10-2000 μm.

83. The aerosol generation device according to claim 80, wherein the first electrode and/or the second electrode have/has a thickness of 0.05-0.5 mm.

84. The aerosol generation device according to claim 80, wherein the plasma generator further comprises:
a dielectric, at least partially located between the first electrode and the second electrode, for inhibiting discharge-to-arc transition between the first electrode and the second electrode.

85. The aerosol generation device according to claim 84, wherein the dielectric comprises at least one of aluminum oxide, zirconium oxide, ceramic, glass, quartz, and an organic polymer.

86. The aerosol generation device according to claim 76, wherein the plasma generator is provided with a high-voltage pulse power supply.

87. The aerosol generation device according claim 76, further comprising:
a cell; and
a circuit board, located between the cell and the plasma generator, and configured to guide and provide an impulse voltage to the plasma generator for the plasma generator to generate the plasma.

88. The aerosol generation device according to claim 87, wherein frequency of the impulse voltage is 1-100 kHz.

89. The aerosol generation device according to claim 87, wherein a voltage amplitude of the impulse voltage is 1-9 kV.

90. The aerosol generation device according to claim 87, wherein an impulse width of the impulse voltage is 10-600 ns.

91. The aerosol generation device according to claim 87, wherein the impulse voltage is obtained by boosting an output voltage of the cell at least twice.

92. The aerosol generation device according to claim 87, wherein the circuit board comprises:
an inverting boost circuit, configured to perform a first boost on a direct-current voltage outputted by the cell;
a Cockcroft-Walton boost circuit, for performing a second boost on an output voltage of the inverting boost circuit; and
a filter circuit, for filtering an output voltage of the Cockcroft-Walton boost circuit to form the impulse voltage.

93. The aerosol generation device according to claim 76, wherein the fluid channel has an inner diameter of 0.1-0.9 mm.

94. The aerosol generation device according to claim 80, wherein:
the plasma generator further comprises a first conducting element and a second conducting element for supplying power to the plasma generator;
the first conducting element is electrically conductive with the first electrode; and
the second conducting element is electrically conductive with the second electrode.

95. The aerosol generation device according to claim 94, wherein:
the plasma generator further comprises a dielectric, the dielectric comprising an end part arranged perpendicular to a longitudinal direction of the dielectric and a peripheral part extending from the end part;
the end part is arranged to be at least partially located between the first electrode and the second electrode, for inhibiting discharge-to-arc transition between the first electrode and the second electrode; and
the peripheral part is arranged to be at least partially located between the first conducting element and the second conducting element, to provide insulation between the first conducting element and the second conducting element.
